(19) United States
(12) Patent Application Publication
(10) Pub. No.: US 2026/0118888 A1
(43) Pub. Date: Apr. 30, 2026

(54) FIRE DETECTION AND AUTOMATIC EXTINGUISHING METHOD AND SYSTEM USING ROBOT

(71) Applicant: SEOROBOTICS CO., LTD., Anyang-si, Gyeonggi-do (KR)

(72) Inventors: Kyu Sun HAN, Suwon-si, Gyeonggi-do (KR); Ho Gun KIM, Hwaseong-si, Gyeonggi-do (KR); Hyung Kak LEE, Gwangju (KR)

(21) Appl. No.: 19/479,312

(22) PCT Filed: Dec. 30, 2024
(86) PCT No.: PCT/KR2024/021380

§ 371 Date: Oct. 27, 2025

(30) Foreign Application Priority Data
Mar. 27, 2024 (KR) 10-2024-0041494

(51) Int. Cl. G05D 1/689; A62C 27/00; G05D 105/55

(52) U.S. Cl. CPC G05D 1/689; A62C 27/00; G05D 2105/55

(57) ABSTRACT

A fire detection and automatic extinguishing method and system using a robot includes a robot configured to, upon detecting a fire during patrol, calculate a distance to a fire location based on a rotation angle toward the fire location from its own position as a reference, move to the fire location, and then spray an extinguishing agent according to a remote instruction; and a control server configured to, when the robot has moved to the fire location and extinguishing preparations are complete, instruct the robot to spray the extinguishing agent.

### TECHNICAL FIELD

The present invention relates to a fire extinguishing system, and more particularly, to a fire detection and automatic extinguishing method and system using a robot, wherein upon detecting a fire during patrol, the robot moves to a position suitable for initial suppression, prepares to aim, notifies a person in charge, and enables the person in charge to remotely click an initial suppression button to extinguish the fire in its early stages.

### BACKGROUND ART

In the event of a fire, a wide variety of extinguishing means exist, ranging from large-scale, facility-type automatic extinguishing systems and fire hydrants to portable fire extinguishers operated by a person. However, with the exception of special equipment mandated by relevant regulations, it is common practice to place fire extinguishers or simple extinguishing means in each area for direct manual operation when needed.

It is common knowledge that such extinguishing means are more effective the closer they are used to the source of the flames in the initial stages of a fire. However, when used by a person unfamiliar with the operating method, the psychological pressure may cause them to operate it from too far away, failing to extinguish the fire, or they may not know how to operate it at all. Furthermore, if a fire occurs at a time and place where no one is present, response and situational awareness cannot be established, leading to a failure in initial suppression.

In addition, due to the nature of combustible materials, it is difficult to approach fires that generate high-temperature flames and combustion gases or pose a risk of explosion, meaning effective initial suppression cannot be achieved. Firefighting efforts also face significant constraints in locations where human movement is restricted due to structural problems.

Consequently, while various unmanned systems and robots that can perform firefighting tasks in place of humans are being actively researched, they have suffered from a critical problem: ineffectiveness in diverse, real-world situations. This issue arises because they are often not only ill-equipped with a proper control system for effectively detecting and extinguishing fires (sometimes featuring merely a fire monitor for the sole purpose of supplying water) but are also designed with performance capabilities specialized only for specific scenarios.

### RELATED ART DOCUMENTS

### Patent Documents

(Patent Document 1) Korean Patent No. 10-1304529
(Patent Document 2) Korean Patent Application Publication No. 10-2021-0055923

### DISCLOSURE

### Technical Problem

Therefore, the present invention has been made in view of the above problems, and it is one object of the present invention to provide a fire detection and automatic extinguishing method and system using a robot that can discover fires early through regular robotic patrols and proceed with remote extinguishing by moving to the fire's location from a distance.

### Technical Solution

In accordance with an aspect of the present invention, the above and other objects can be accomplished by the provision of a fire detection and automatic extinguishing system using a robot, the fire detection and automatic extinguishing system including: a robot configured to, upon detecting a fire during patrol, calculate a distance to a fire location based on a rotation angle toward the fire location from its own position as a reference, move to the fire location, and then spray an extinguishing agent according to a remote instruction; and a control server configured to, when the robot has moved to the fire location and extinguishing preparations are complete, instruct the robot to spray the extinguishing agent.

Preferably, the robot may determine whether an abnormally high temperature has occurred and, if an abnormally high temperature has occurred, transmit an abnormal high-temperature warning message to the control server, and the control server may determine whether a fire has been detected based on the abnormal high-temperature warning message.

Preferably, the robot, after spraying the extinguishing agent and after a preset time has elapsed, may determine whether a temperature at the fire location has risen, and if the temperature at the fire location has risen, may transmit a fire suppression failure warning message to the control server.

Preferably, the robot may move from a current position to an arbitrary position and then may calculate a distance to the fire location based on angles formed by an X-axis and the fire location, using both the current position and the arbitrary position as respective origins.

Preferably, the robot may calculate the distance to the fire location using a mathematical formula below:

$$[ \begin{matrix}{P}_{x} \\ {P}_{y}\end{matrix} ] = {[ \begin{matrix}tan {θ}_{1} - 1 \\ tan {θ}_{2} - 1\end{matrix} ]}^{- 1} [ \begin{matrix}- {y}_{1} + {x}_{1} tan {θ}_{1} \\ - {y}_{2} + {x}_{2} tan {θ}_{2}\end{matrix} ] \qquad [ Mathematical Formula ]$$

where (Pₓ, P_{y}) represents coordinates of the fire location, (x₁, y₁) represents coordinates of the current position, (x₂, y₂) represents coordinates of the arbitrary position, θ₁ represents an angle formed between the X-axis and the fire location with the current position as the origin, and θ₂ represents an angle formed between the X-axis and the fire location with the arbitrary position as the origin.

In accordance with another aspect of the present invention, there is provided a fire detection and automatic extinguishing method using a robot, the fire detection and automatic extinguishing method including: calculating, by the robot, a distance to a fire location based on a rotation angle toward the fire location from the robot's own position as a reference, upon detecting a fire during patrol; allowing the robot to move to the fire location by referencing the distance to the fire location; and instructing, by a control server, the robot to spray an extinguishing agent via a remote instruction when the robot has moved to the fire location and extinguishing preparations are complete.

Preferably, the fire detection and automatic extinguishing method may further include: determining, by the robot, whether a temperature at the fire location has risen after spraying the extinguishing agent and after a preset time has elapsed; and transmitting, by the robot, a fire suppression failure warning message to the control server when the temperature at the fire location has risen.

### Advantageous Effects

As described above, the present specification provides a fire detection and automatic extinguishing method and system using a robot, wherein upon detecting a fire during patrol, the robot calculates the distance to the fire location based on a rotation angle toward the fire location from its own position as a reference, moves to the fire location, and then sprays an extinguishing agent according to a remote instruction, and wherein a control server instructs the robot to spray the extinguishing agent when the robot's extinguishing preparations are complete, thereby making it possible to discover fires early through regular robotic patrols and to proceed with remote extinguishing by moving to the fire's location from a distance.

### DESCRIPTION OF DRAWINGS

FIG. 1 is a block diagram illustrating the schematic configuration of a fire detection and automatic extinguishing system using a robot according to an embodiment of the present invention.

FIG. 2 is a diagram for explaining a method of calculating the distance to a fire location.

FIG. 3 is a block diagram illustrating the schematic internal configuration of the robot according to an embodiment of the present invention.

FIG. 4 is a block diagram illustrating the schematic internal configuration of a control server according to an embodiment of the present invention.

FIG. 5 is a flowchart illustrating a fire detection and automatic extinguishing method using the robot according to an embodiment of the present invention.

### BEST MODE

The terminology used herein is for the purpose of describing particular embodiments only and is not intended to be limiting of the present invention. Unless otherwise defined, all technical terms used herein have the same meaning as commonly understood by one of ordinary skill in the art to which this present invention belongs and will not be interpreted in overly wide or narrow sense unless expressly so defined herein. If a term used herein is a wrong term by which one of ordinary skill in the art cannot correctly understand the present invention, the wrong term should be replaced by a technical term by which one of ordinary skill in the art can correctly understand the present invention. It will be further understood that terms, such as those defined in commonly used dictionaries, should be interpreted as having a meaning that is consistent with their meaning in the context of the relevant art and will not be interpreted in an overly narrow sense.

As used herein, the singular forms “a,” “an” and “the” are intended to include the plural forms as well, unless the context clearly indicates otherwise. It will be further understood that the terms “comprises” or “comprising” are not intended to include all elements or all steps described herein, but do not preclude exclusion of some elements or steps described herein or addition of one or more other elements or steps.

Furthermore, the suffixes “module” and “unit,” when appended to components in this specification, are assigned or used interchangeably solely for convenience in drafting the description and do not, in themselves, denote distinct meanings or roles.

It will be understood that, although the terms first, second, third etc. may be used herein to describe various elements, these elements should not be limited by these terms. These terms are only used to distinguish one element from another element. For example, a first element may be termed a second element and a second element may be termed a first element without departing from the teachings of the present invention.

### DESCRIPTION OF SYMBOLS

100: robot 110: communicator
120: sensor 130: thermal imaging camera
140: controller 141: motion generator
142: driving controller 143: monitoring part
150: storage 200: control server
210: communicator 220: information generator
230: situation propagator

### MODE FOR CARRYING OUT THE INVENTION

Hereinafter, the present invention will be described in detail by explaining exemplary embodiments of the invention with reference to the attached drawings. The same reference numerals in the drawings denote like elements, and a repeated explanation thereof will not be given.

In the description of the present invention, certain detailed explanations of related art are omitted when it is deemed that they may unnecessarily obscure the essence of the invention. The features of the present invention will be more clearly understood from the accompanying drawings and should not be limited by the accompanying drawings.

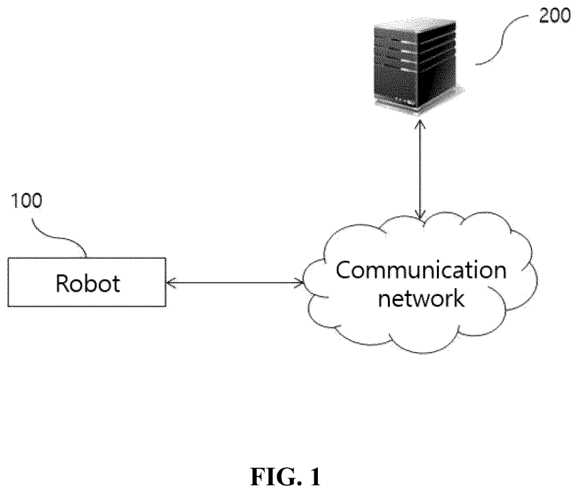

FIG. 1 is a block diagram illustrating the schematic configuration of a fire detection and automatic extinguishing system using a robot according to an embodiment of the present invention.

Referring to FIG. 1, the fire detection and automatic extinguishing system using the robot according to the present invention may include a robot 100 and a control server 200.

The robot 100 detects a fire. Specifically, the robot 100 determines whether an abnormally high temperature has occurred, and if so, transmits an abnormal high-temperature warning message to the control server 200. The control server 200 then determines whether a fire has been detected based on the abnormal high-temperature warning message.

When the robot 100 detects a fire during patrol, it calculates the distance to the fire location based on a rotation angle toward the fire location from its own position as a reference. Specifically, the robot 100 moves from its current position to an arbitrary position and then calculates the distance to the fire location based on the angles formed by the X-axis and the fire location, using both the current position and the arbitrary position as respective origins.

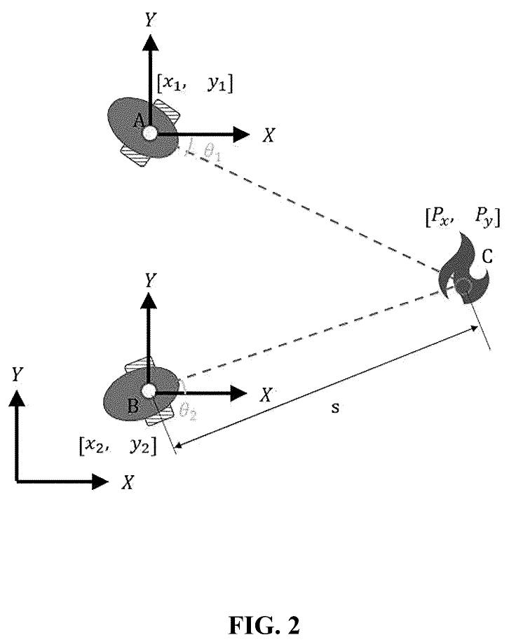

To explain in detail with reference to FIG. 2, the path line of the robot 100 from point A in an absolute coordinate system is expressed by the following Equation 1, and the path line of the robot 100 from point B in the absolute coordinate system can be expressed by the following Equation 2:

$$y = tan {θ}_{1} ( x - {x}_{1} ) + {y}_{1} \qquad [ Equation 1 ]$$

where (x₁, y₁) are the coordinates of a current position, and θ1 represents the angle formed between the X-axis and a fire location when the current position is the origin.

$$y = tan {θ}_{2} ( x - {x}_{2} ) + {y}_{2} \qquad [ Equation 2 ]$$

where (x₂, y₂) are the coordinates of an arbitrary position, and θ2 represents the angle formed between the X-axis and a fire location when the arbitrary position is the origin.

The coordinates of the fire location, obtained using Equations 1 and 2 above, can be expressed as the following Equation 3:

$${P}_{y} = tan {θ}_{1} ( {P}_{x} - {x}_{1} ) + {y}_{1} \\ {P}_{y} = tan {θ}_{2} ( {P}_{x} - {x}_{2} ) + {y}_{2} \qquad [ Equation 3 ]$$

where (Px, Py) represent the coordinates of the fire location.

Equation 3 above can be rearranged as the following Equation 4:

$$tan {θ}_{1} {P}_{x} - {P}_{y} = - {y}_{1} + tan {θ}_{1} {x}_{1} \\ tan {θ}_{2} {P}_{x} - {P}_{y} = - {y}_{2} + tan {θ}_{2} {x}_{2} \qquad [ Equation 4 ]$$

Equation 4, when expressed in matrix form, is the same as the following Equation 5:

$$[ \begin{matrix}tan {θ}_{1} - 1 \\ tan {θ}_{2} - 1\end{matrix} ] [ \begin{matrix}{P}_{x} \\ {P}_{y}\end{matrix} ] = [ \begin{matrix}- {y}_{1} + {x}_{1} tan {θ}_{1} \\ - {y}_{2} + {x}_{2} tan {θ}_{2}\end{matrix} ] \qquad [ Equation 5 ]$$

Finally, the following Equation 6, which is used for calculating the distance to the fire location, can be derived by rearranging Equation 5 above:

$$[ \begin{matrix}{P}_{x} \\ {P}_{y}\end{matrix} ] = {[ \begin{matrix}tan {θ}_{1} - 1 \\ tan {θ}_{2} - 1\end{matrix} ]}^{- 1} [ \begin{matrix}- {y}_{1} + {x}_{1} tan {θ}_{1} \\ - {y}_{2} + {x}_{2} tan {θ}_{2}\end{matrix} ] \qquad [ Equation 6 ]$$

The robot 100 calculates the distance to the fire location using Equation 6, moves to the fire location by referencing this distance, and then sprays an extinguishing agent according to a remote instruction from the control server 200. Since it is difficult to perform initial suppression if the robot 100 proceeds with extinguishing from too far away, it calculates the proper distance required for initial suppression.

In addition, after spraying the extinguishing agent and after a preset time (e.g., 1 minute) has elapsed, the robot 100 determines whether the temperature at the fire location has risen, and if the temperature has risen, it can transmit a fire suppression failure warning message to the control server 200.

The control server 200 is located at a remote site and can grasp the on-site situation through the abnormal high-temperature warning message and fire suppression failure warning message received from the robot 100, and can perform situation propagation and remotely control the robot 100 if necessary. For example, when the robot 100 has moved to the fire location and its extinguishing preparations are complete, the control server 200 may instruct the robot 100 to spray the extinguishing agent.

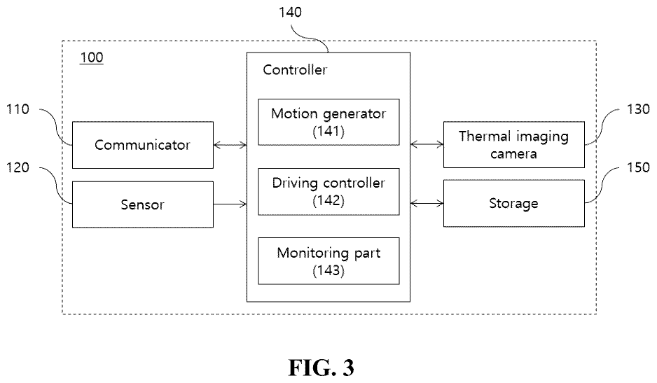

FIG. 3 is a block diagram illustrating the schematic internal configuration of the robot according to an embodiment of the present invention.

Referring to FIG. 3, the robot 100 may include a communicator 110, a sensor 120, a thermal imaging camera 130, a controller 140 and a storage 150.

The communicator 110 performs communication with the control server 200. At this time, the communicator 110 may use a wireless communication network to communicate with the control server 200. The communicator 110 may transmit an abnormal high-temperature warning message, a fire suppression failure warning message, and the like to the control server 200, and may receive remote instructions from the control server 200.

The sensor 120 measures the movement, posture, and extinguishing agent spray amount of the robot 100. That is, the sensor 120 measures a velocity, acceleration, direction, and gravity generated by the movement of the robot 100. The sensor 120 measures the posture for the 2-degrees-of-freedom (DOF) motion of the robot 100. In addition, the sensor 120 measures the amount of extinguishing agent that is sprayed. To this end, the sensor 120 may include an Inertial Measurement Unit (IMU), a torque sensor, a flow sensor, and the like.

The thermal imaging camera 130 captures thermal images. The thermal imaging camera 130 photographs the fire location and detects a point (ignition point) with the highest temperature within the fire location. That is, the thermal imaging camera 130 may capture thermal images while tracking the ignition point.

The controller 140 controls the overall operation of the robot 100. That is, the controller 140 generates movements for fire suppression and controls the extinguishing agent to be sprayed according to the generated movements. In addition, the controller 140 may monitor information related to fire suppression. To this end, the controller 140 includes a motion generator 141 and a driving controller 142, and may further include a monitoring part 143.

The motion generator 141 generates a movement control signal for the operation of the 2-degrees-of-freedom (DOF) motion for moving to the fire location and spraying the extinguishing agent. The motion generator 141 calculates the distance between the robot 100 and the fire location over time using the aforementioned Equation 6.

The motion generator 141 generates a movement control signal for the yaw motion using the x-axis length, y-axis length, travel speed, and time from the current position to the fire location. The motion generator 141 calculates the angle of the yaw motion for each time point using the following Equation 7, and generates a movement control signal using the calculated angle of the yaw motion. Here, since the yaw motion is not affected by gravity, Equation 7 may be derived with gravity excluded.

$${θ}_{yaw} ( t ) = {tan}^{- 1} ( \frac{{A}_{x} - {v}_{robot} t}{{A}_{y}} ) \qquad [ Equation 7 ]$$

where θ_{yaw}(t) represents the angle for the yaw motion at time t.

That is, Equation 7 represents the angle of a yaw motion that changes according to time t as the robot 100 moves at a travel speed (V_{robot}).

The motion generator 141 compares the distance between the robot 100 and the fire location with the maximum extinguishing agent spray distance that is the maximum horizontal distance the extinguishing agent can be sprayed. The motion generator 141 calculates the maximum extinguishing agent spray distance using the following Equation 8:

$${w}_{w @ t} = ( {V}_{w @ t} cos {θ}_{pitch @ t} ) {t}_{w @ t} \qquad [ Equation 8 ]$$

where W_{w@t} represents the maximum extinguishing agent spray distance at time t for a robot with a travel speed V_{robot}, V_{w@t} represents the spray velocity of the extinguishing agent sprayed at time t by a robot with a travel speed V_{robot}, θ_{pitch@t} represents the angle for the pitch motion at time t of a robot with a travel speed V_{robot}, and twat represents the time consumed for the sprayed agent to reach the ground after being sprayed at a velocity V_{w@t} at time t by a robot with a travel speed V_{robot}. Here, the motion generator 141 calculates twat using the following Equation 9:

$$\frac{g}{2} {t}_{w @ t}^{2} - ( {V}_{w @ t} sin {θ}_{pitch @ t} ) {t}_{w @ t} = 0 \qquad [ Equation 9 ]$$

where g represents the gravitational constant.

When the distance (Sₜ) between the robot 100 and the fire location is greater than the maximum extinguishing agent spray distance (W_{w@t}) (Sₜ>W_{w@t}), the robot 100 will not spray the extinguishing agent; therefore, the motion generator 141 calculates the angle of the pitch motion as shown in the following Equation 10 and generates a movement control signal using the calculated angle.

$${θ}_{pitch @ t + δ t} = 0 \qquad [ Equation 10 ]$$

where θ_{pitch@t+δt} represents the angle of the pitch motion at time t+δt, and δt represents the calculation time increment.

In addition, when the distance between the robot 100 and the fire location is less than or equal to the maximum extinguishing agent spray distance (S₁≤W_{w@t}), the robot 100 will spray the extinguishing agent; therefore, the motion generator 141 calculates the angle of the pitch motion for each time point as shown in the following Equation 11 and generates a movement control signal using the calculated angle of the pitch motion. Here, the motion generator 141 can calculate the optimized angle of the pitch motion using the numerical analysis Newton-Raphson method.

$$\frac{d [ {W}_{w @ t} - {S}_{t} ]}{d {θ}_{pitch @ t}} = 0 \qquad [ Equation 11 ]$$

The motion generator 141 can repeatedly calculate the angle of the pitch motion until the movement completion time (t_{end}) of the robot 100. Through this, the motion generator 141 can calculate the optimized angle of the pitch motion in real time.

When the movement to the fire location is complete, the motion generator 141 detects a point with the highest temperature within the fire location using the thermal image transmitted from the thermal imaging camera 130. The motion generator 141 can generate a movement control signal to perform a concentrated spray of the extinguishing agent on the detected point. Preferably, the motion generator 141 can adjust the spray amount of the extinguishing agent for the concentrated spray while sensing the amount of extinguishing agent currently held in an extinguishing agent storage (not shown) and the amount being sprayed.

The driving controller 142 controls the operation of the robot 100. In detail, the driving controller 142 controls the movement to the fire occurrence point and the spraying of the extinguishing agent based on the movement control signal. For example, when the robot 100 reaches a point where spraying the extinguishing agent is possible during its movement, the driving controller 142 controls the spraying of the extinguishing agent, and when the movement is complete, it controls the concentrated spraying of the extinguishing agent on the fire location.

The monitoring part 143 monitors the process of the robot 100 suppressing the fire. The monitoring part 143 collects information from the moment a remote instruction is received from the control server 200 until the moment the fire is suppressed. At this time, the monitoring part 143 may collect information such as thermal image information and the robot 100's operational information. The monitoring part 143 may transmit the collected monitoring information to the control server 200 or temporarily store it for a certain period.

The storage 150 stores a program or algorithm for driving the robot 100. Information related to the location of the fire point and movement is stored in the storage 150. In addition, monitoring information that records the fire suppression process is stored in the storage 150. The storage 150 may include at least one storage medium from among a flash memory type, a hard disk type, a multimedia card micro type, a card-type memory (e.g., SD or XD memory, etc.), Random Access Memory (RAM), Static Random Access Memory (SRAM), Read-Only Memory (ROM), Electrically Erasable Programmable Read-Only Memory (EEPROM), Programmable Read-Only Memory (PROM), magnetic memory, a magnetic disk, and an optical disc.

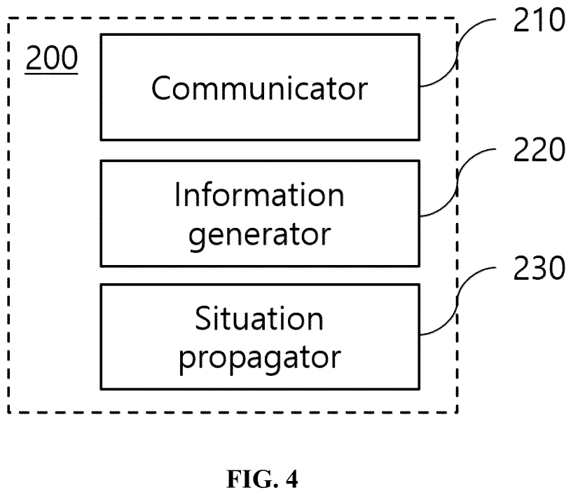

FIG. 4 is a block diagram illustrating the schematic internal configuration of a control server according to an embodiment of the present invention.

Referring to FIG. 4, a control server 200 according to the present invention may include a communicator 210, an information generator 220 and a situation propagator 230.

The communicator 210 is a communication module for transmitting and receiving control signals with the communicator 110 of the robot 100. It may be configured as a wireless communication module like the communicator 110, but if a wireless repeater is provided, it may also be connected to the repeater via a wired connection.

The information generation unit 220 is a component that generates situation information by analyzing abnormal high-temperature warning messages, fire suppression failure warning messages, images, and various control signals received from the robot 100, and it periodically generates situation information for each location of the robot 100. At this time, the information generator 220 can, if necessary, generate a patrol signal including the path line of the robot 100 and transmit it to the robot 100 via the communicator 210, thereby causing the robot 100 to move along a designated path and transmit captured images via the thermal imaging camera 130. The transmitted images may be included in the situation information according to the passage of time.

The situation propagator 230 classifies the situation information, and in the case of a set situation (that is, a situation that can be determined as a fire outbreak), it may propagate the corresponding situation information to a designated terminal (not shown). To this end, the situation propagator 230 may store phone numbers or IP addresses for contacting public offices, such as a fire station that includes a pre-designated terminal (not shown), to propagate the situation promptly.

In addition to this, the control server 200 may include a conventional computer configuration including an interface part, such as an input/output part, a central processing unit, and a storage unit.

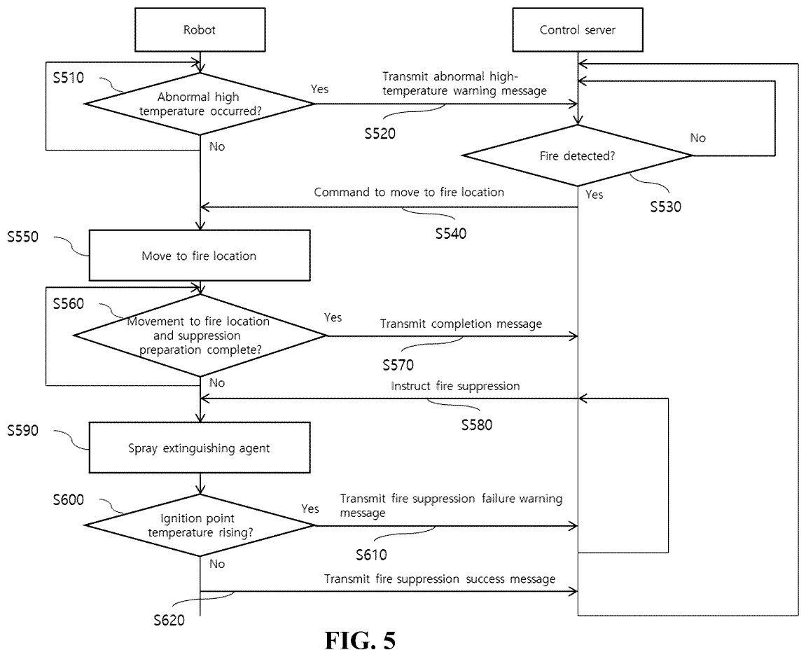

FIG. 5 is a flowchart illustrating a fire detection and automatic extinguishing method using the robot according to an embodiment of the present invention.

Referring to FIG. 5, the robot 100 determines whether an abnormally high temperature has occurred while on patrol (S510), and if an abnormally high temperature has occurred, it transmits an abnormal high-temperature warning message to the control server 200 (S520). Here, the robot 100 may determine whether an abnormally high temperature has occurred by photographing the fire location using the thermal imaging camera 130 and detecting the point with the highest temperature (ignition point) within the fire location.

If an abnormally high temperature has not occurred, the robot 100 continues its patrol.

The control server 200 determines whether a fire has been detected based on the abnormal high-temperature warning message received from the robot 100 (S530), and if a fire is detected, it commands the robot 100 to move to the fire location (S540). If a fire is not detected, the control server 200 stands by.

The robot 100 moves to the fire location in accordance with the command from the control server 200 (S550). At this time, before moving to the fire location, the robot 100 may calculate the distance to the fire location based on the rotation angle toward the fire location from its own position as a reference. Specifically, the robot 100 may move from its current position to an arbitrary position, and then calculate the distance to the fire location based on the angles formed by the X-axis and the fire location, using both the current position and the arbitrary position as respective origins.

Next, the robot 100 determines whether the movement to the fire location and the extinguishing preparations are complete (S560), and if the movement and preparations are complete, it transmits a completion message to the control server 200 (S570)

Upon receiving the completion message from the robot 100, the control server 200 remotely instructs the suppression of the fire (S580).

The robot 100 sprays the extinguishing agent toward the ignition point according to the fire suppression instruction from the control server 200 (S590).

Next, the robot 100 determines whether the temperature of the ignition point is rising (S600), and if the temperature of the ignition point rises, it transmits a fire suppression failure warning message to the control server 200 (S610). Upon receiving the fire suppression failure warning message, the control server 200 returns to step S580 and once again instructs the robot 100 to suppress the fire.

And, if the temperature of the ignition point has not risen, the robot 100 transmits a fire suppression completion message to the control server 200 (S620). Upon receiving the fire suppression completion message, the control server 200 stands by again.

The method described above may be implemented through various means. For example, embodiments of the present invention may be implemented by hardware, firmware, software, or a combination thereof.

For hardware implementation, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, and microprocessors.

For firmware or software implementation, the method according to the embodiments of the present invention may be implemented in the form of a module, procedure, or function that performs the functions or operations described above. The software code may be stored in a memory unit and executed by a processor. The memory unit may be located inside or outside the processor and may exchange data with the processor through various well-known means.

The embodiments disclosed in the present specification have been described above with reference to the accompanying drawings. The embodiments shown in the respective drawings are not to be construed as limiting, and it is to be interpreted that they may be combined with each other by a person skilled in the art who has an understanding of the contents of the present specification, and in the case of combination, some components may be omitted.

Here, terms or words used in the present specification and the accompanying claims should not be construed as being limited to their ordinary or dictionary meanings, and should be construed with meanings and concepts consistent with the technical idea disclosed in the present specification.

Therefore, it should be understood that the embodiments described in the present specification and the configurations shown in the drawings are merely illustrative of the embodiments disclosed in the present specification and do not represent all of the technical ideas disclosed in the present specification, and that there may be various equivalents and modifications that can replace them at the time of filing the present application.

1. A fire detection and automatic extinguishing system using a robot, the fire detection and automatic extinguishing system comprising:
a robot configured to, upon detecting a fire during patrol, calculate a distance to a fire location based on a rotation angle toward the fire location from its own position as a reference, move to the fire location, and then spray an extinguishing agent according to a remote instruction; and
a control server configured to, when the robot has moved to the fire location and extinguishing preparations are complete, instruct the robot to spray the extinguishing agent,
wherein the robot determines whether an abnormally high temperature has occurred and, if an abnormally high temperature has occurred, transmits an abnormal high-temperature warning message to the control server, and the control server determines whether a fire has been detected based on the abnormal high-temperature warning message,
wherein the robot, after spraying the extinguishing agent and after a preset time has elapsed, determines whether a temperature at the fire location has risen, and if the temperature at the fire location has risen, transmits a fire suppression failure warning message to the control server,
wherein the robot moves from a current position to an arbitrary position and then calculates a distance to the fire location based on angles formed by an X-axis and the fire location, using both the current position and the arbitrary position as respective origins,
wherein the robot calculates the distance to the fire location using Mathematical Formula 1 below,
wherein the robot comprises a controller, the controller comprises a motion generator,
wherein the motion generator is configured to calculate an angle of a yaw motion over time using Mathematical Formula 2 below to generate a motion control signal of the robot,
wherein the motion generator is configured to calculate a maximum extinguishing liquid spraying distance using Mathematical Formula 3 below,
wherein the Mathematical Formula 1 is:
$$[ \begin{matrix}{P}_{x} \\ {P}_{y}\end{matrix} ] = {[ \begin{matrix}tan {θ}_{1} - 1 \\ tan {θ}_{2} - 1\end{matrix} ]}^{- 1} [ \begin{matrix}- {y}_{1} + {x}_{1} tan {θ}_{1} \\ - {y}_{2} + {x}_{2} tan {θ}_{2}\end{matrix} ]$$
where (Pₓ, P_{y}) represents coordinates of the fire location, (x₁, y₁) represents coordinates of the current position, (x₂, y₂) represents coordinates of the arbitrary position, θ₁ represents an angle formed between the X-axis and the fire location with the current position as the origin, and θ₂ represents an angle formed between the X-axis and the fire location with the arbitrary position as the origin,
wherein the Mathematical Formula 2 is:
$${θ}_{yaw} ( t ) = {tan}^{- 1} ( \frac{{A}_{x} - {v}_{robot} t}{{A}_{y}} )$$
where θ_{yaw}(t) represents the angle for the yaw motion that changes according to time t as the robot moves at a travel speed (V_{robot}), Ax represents the x-axis length from the robot's initial position to the fire location, and Ay represents the y-axis length, and
wherein the Mathematical Formula 3 is:
$${w}_{w @ t} = ( {V}_{w @ t} cos {θ}_{pitch @ t} ) {t}_{w @ t}$$
where W_{w@t} represents the maximum extinguishing agent spray distance at time t for a robot with a travel speed V_{robot}, V_{w@t} represents the spray velocity of the extinguishing agent sprayed at time t by a robot with a travel speed V_{robot}; θ_{pitch@t} represents the angle for the pitch motion at time t of a robot with a travel speed V_{robot}; and t_{w@t} represents the time consumed for the sprayed agent to reach the ground after being sprayed at a velocity V_{w@t} at time t by a robot with a travel speed V_{robot}.

2-5. (canceled)

6. A fire detection and automatic extinguishing method using a robot, the fire detection and automatic extinguishing method comprising:
calculating, by the robot, a distance to a fire location based on a rotation angle toward the fire location from the robot's own position as a reference, upon detecting a fire during patrol;
moving the robot to the fire location by referencing the distance to the fire location; and
instructing, by a control server, the robot to spray an extinguishing agent via a remote instruction when the robot has moved to the fire location and extinguishing preparations are complete.

7. The fire detection and automatic extinguishing method according to claim 6, further comprising:
determining, by the robot, whether a temperature at the fire location has risen after spraying the extinguishing agent and after a preset time has elapsed; and
transmitting, by the robot, a fire suppression failure warning message to the control server when the temperature at the fire location has risen.
